(19) United States
(12) Patent Application Publication
(10) Pub. No.: US 2026/0125238 A1
(43) Pub. Date: May 7, 2026

(54) Data Cable Device

(71) Applicant: Anker Innovations Technology Co., Ltd., Changsha (CN)

(72) Inventors: Xianjie Tang, Shenzhen (CN); Tao Chen, Shenzhen (CN); Xiang Zhang, Shenzhen (CN)

(21) Appl. No.: 19/438,777

(22) Filed: Jan. 2, 2026

Related U.S. Application Data
(63) Continuation of application No. PCT/CN2024/103089, filed on Jul. 2, 2024.

(30) Foreign Application Priority Data
Jul. 3, 2023 (CN) 202310807330.0

(51) Int. Cl. B65H 75/44; B65H 75/48; H01B 7/04; H01B 7/06

(52) U.S. Cl. CPC B65H 75/4418; B65H 75/4402; B65H 75/4471; B65H 75/48; H01B 7/04; H01B 7/06

(57) ABSTRACT

A data cable device comprises a base, a retracting assembly, a data cable, and a release control assembly. The retracting assembly comprises a winding frame and a driving structure. The winding frame is in rotating connection with the base. The driving structure is connected to the winding frame and is configured to drive the winding frame to rotate relative to the base. The data cable is wound around the winding frame. The release control assembly is in electric connection with the data cable, and is configured to generate a control signal based on an interface of the data cable not being connected to an external device, and cause the driving structure to drive the winding frame to rotate relative to the base based on the control signal.

### CROSS-REFERENCE TO RELATED APPLICATIONS

The present application is a continuation application of PCT/CN2024/103089, filed on July 2, 2024, which claims priority of Chinese Patent Application No. 202310807330.0, filed on July 3, 2023, and entitled “Data Cable Device”, each of which is incorporated herein by reference in its entirety.

### FIELD

The present disclosure relates to the technical field of data cable retraction, in particular to a data cable device.

### BACKGROUND

Currently, most retractable data cables on the market adopt a press-type retraction mechanism. Specifically, a press key is actuated to lift a boss, allowing it to disengage from a catching point on a cord reel, thereby enabling automatic cable retraction. This manner requires a user to press the press key each time the cable is retracted, resulting in inconvenient operation and a poor user experience. Therefore, improving the convenience and usability of data cable retraction has become an issue that needs to be addressed.

### SUMMARY

The present disclosure describes a data cable device, which can improve the convenience and usability of automatic data cable retraction.

Examples of the present disclosure describe a data cable device comprising a base, a retracting assembly, a data cable, and a release control assembly. The retracting assembly comprises a winding frame and a driving structure. The winding frame is in rotating connection with the base. The driving structure is connected to the winding frame and is configured to drive the winding frame to rotate relative to the base. The data cable is wound around the winding frame, and an interface of the data cable is configured to be connected to an external device. The release control assembly is in electric connection with the data cable, and configured to generate a control signal based on determining that the interface of the data cable is not connected to the external device, and cause the driving structure to drive the winding frame to rotate relative to the base based on the control signal, so as to realize automatic retraction of the data cable.

Based on the data cable device in the present disclosure, by including the release control assembly, when the release control assembly acquires that the interface of the data cable is not connected to the external device, and release control assembly can control the driving structure to drive the winding frame to rotate relative to the base, so as to realize the automatic retraction of the data cable. In the related art, a user realizes retraction of the data cable by manually pressing a press key. The present application omits the manual pressing operation of the user, which can effectively improve the convenience of automatic retraction of the data cable.

### BRIEF DESCRIPTION OF THE DRAWINGS

In order to more clearly illustrate technical solutions in the present disclosure, drawings that need to be used in description of the examples are briefly introduced below, and it will be apparent in to those of ordinary skill in the art that the drawings in the following description are only some examples of the disclosure, and other drawings can be obtained in accordance with these drawings without inventive work.

FIG. 1 is a schematic structural diagram of a data cable device in an example of the present disclosure;

FIG. 2 is a schematic structural diagram of a data cable device in an example of the present disclosure from another visual angle;

FIG. 3 is an exploded schematic structural diagram of a data cable device in an example of the present disclosure;

FIG. 4 is a schematic structural diagram in which a locking member is embedded in a catching point groove of an annular guide groove in an example of the present disclosure;

FIG. 5 is a schematic structural diagram of an annular guide groove in an example of the present disclosure;

FIG. 6 is a schematic structural diagram in which a releasing member is not energized, and a locking member is in a limiting groove in an example of the present disclosure;

FIG. 7 is a schematic structural diagram in which a releasing member is energized, and a locking member is in a limiting groove in an example of the present disclosure;

FIG. 8 is a schematic flow chart of automatic retraction of a data cable in an example of the present disclosure;

FIG. 9 is a schematic structural diagram of a limiting groove and a snap connection groove on a base in an example of the present disclosure;

FIG. 10 is a schematic structural diagram of a limiting groove and a snap connection groove on a base in an example of the present disclosure from another visual angle;

FIG. 11 is a schematic structural diagram of a notch on a base in an example of the present disclosure;

FIG. 12 is a schematic structural diagram in which a first circuit board and a second circuit board are in electric connection in an example of the present disclosure; and

FIG. 13 is a disassembled schematic structural diagram of a first circuit board and a second circuit board in an example of the present disclosure.

### REFERENCE NUMERALS

1, data cable device; 10, base; 11, first bearing surface; 12, second bearing surface; 13, limiting groove; 131, arc-shaped groove sidewall; 14, snap connection groove; 15: notch; 20, retracting assembly; 21, winding frame; 211, rotary shaft; 2111, slot; 212, support frame; 2121, first frame body; 21211, annular guide groove; 21212, catching point groove; 2122, second frame body; 22, driving structure; 221, locking member; 2211, locking main body; 2212, locking protrusion; 222, spiral spring; 2221, moving end of spiral spring; 2222, non-moving end of spiral spring; 30, data cable; 31, interface of data cable; 50, release control assembly; 51, releasing member; 52, electric connection member; 53, first circuit board; 531, first board body; 532, electric connection piece; 54, second circuit board; 541, second board body; 542, electric contact point; 60, first cover body; 61, wire-passing hole; 62, through hole; 70, second cover body; 80, plug-in member.

### DETAILED DESCRIPTION

In order to make understanding of the object, technical solutions and advantages of the present disclosure clearer, the present disclosure will be described in further detail below with reference to the accompanying drawings. It should be understood that the specific examples described herein are only used to explain the disclosure and are not used to limit the disclosure.

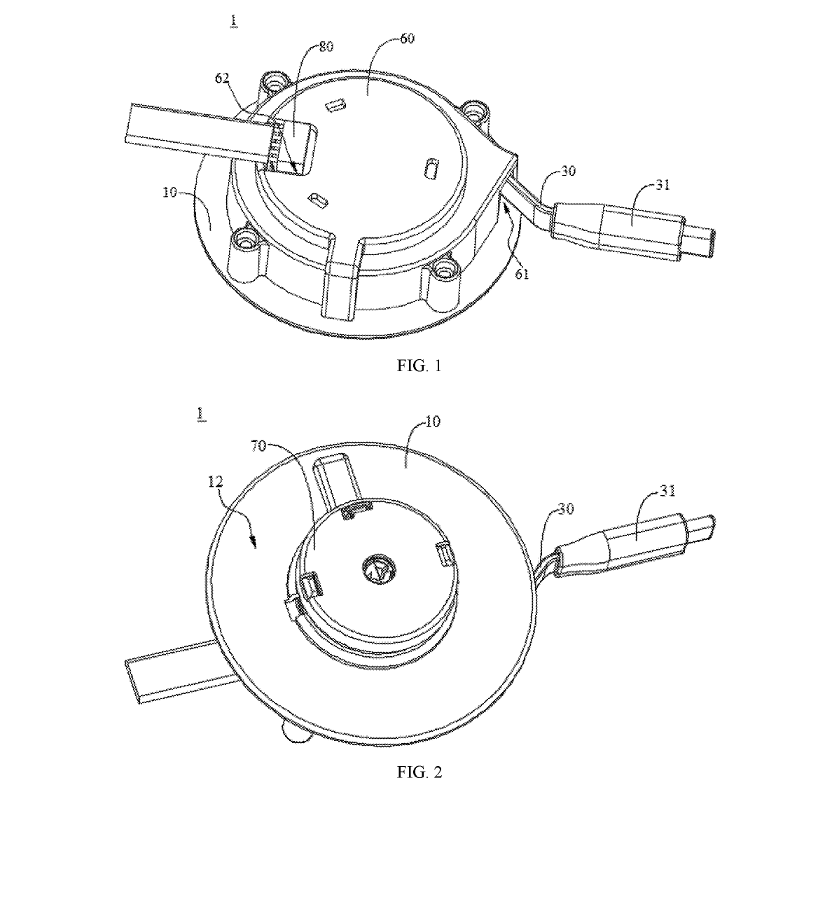

Referring to FIG. 1 to FIG. 3, a first aspect of the present disclosure provides a data cable device 1 which can effectively improve the convenience of automatic retraction of a data cable 30.

The data cable device 1 may include a base 10, a retracting assembly 20, a data cable 30, and a release control assembly 50. The retracting assembly 20 may include a winding frame 21 and a driving structure 22. The winding frame 21 may be in rotating connection with the base 10. The driving structure 22 may be connected to the winding frame 21, and may be configured to drive the winding frame 21 to rotate relative to the base 10. The data cable 30 may be wound around the winding frame 21. And an interface 31 of the data cable may be configured to be connected to an external device. The release control assembly 50 may be in electric connection with the data cable 30, and may be configured to generate a control signal when it is acquired that the interface 31 of the data cable is not connected to the external device, and may cause the driving structure 22 to drive the winding frame 21 to rotate relative to the base 10 according to the control signal, so as to realize the automatic retraction of the data cable 30.

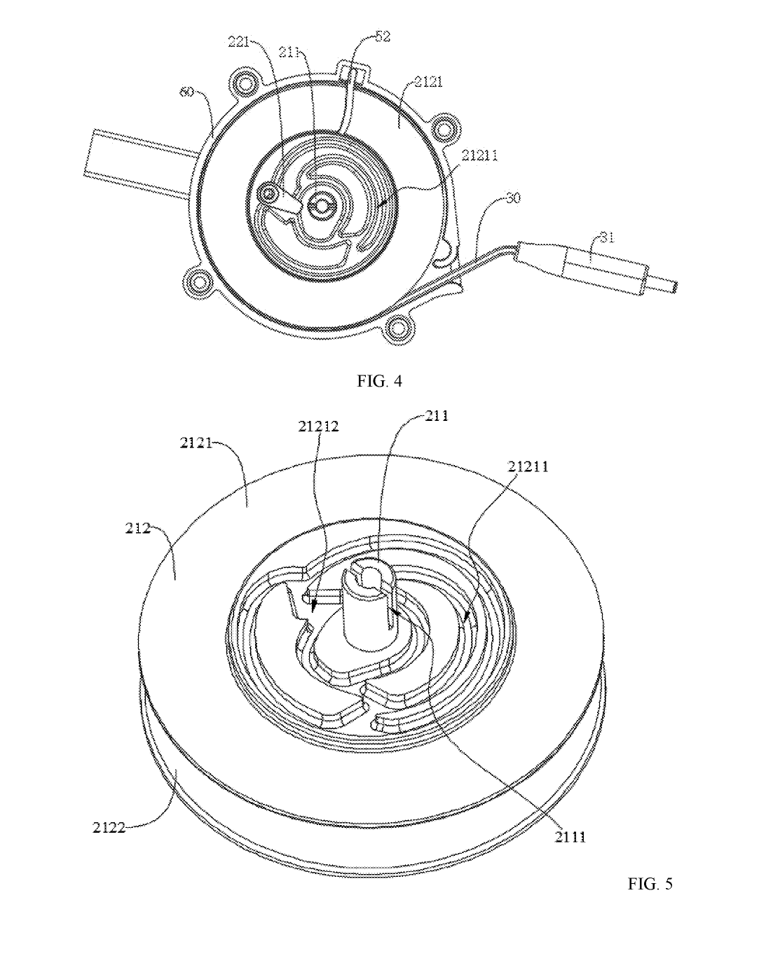

The specific structure of the data cable device 1 is introduced in detail below with reference to FIG. 1 to FIG. 13. The base 10 serves as a carrier for bearing other components in the data cable device 1. The specific shape of the base 10 is not limited here, and a designer can make reasonable designs according to actual needs. The specific preparation material of the base 10 is also not limited here, and the designer can make reasonable designs according to actual needs.

The retracting assembly 20 serves as a structural member in the data cable device 1 for retracting the data cable 30 (to be introduced below). The retracting assembly 20 includes the winding frame 21 and the driving structure 22. As a carrier of the data cable 30, the winding frame 21 is configured to wind the data cable 30. The winding frame 21 is in rotating connection with the base 10. For example, the winding frame 21 may be, but is not limited to be, connected to the base 10 through a bearing. The specific structure of the winding frame 21 will be introduced in detail below.

As a structural member for realizing retraction of the data cable 30, the driving structure 22 may provide a driving force for retraction of the data cable 30. The driving structure 22 may be connected to the winding frame 21, the driving structure 22 may be configured to drive the winding frame 21 to rotate relative to the base 10. The winding frame 21 may rotate relative to the base 10 under the action of the driving structure 22. The specific representation form of the driving structure 22 will be introduced in detail below.

As a structural member for realizing power or signal transmission in the data cable device 1, the data cable 30 may be wound around the winding frame 21. The specific model of the data cable 30 is not limited here, and the designer can make reasonable choice according to actual needs. The interface 31 of the data cable is configured to be connected to an external device, which may be, but is not limited to, a mobile phone or a charging device. It needs to be noted that, the number of the interface 31 of the data cable may be one or multiple (two or more). When the number of the interface 31 of the data cable is one, the type of the interface may be, but is not limited to, one of a USB interface, a type-C interface, and a type-A interface. When the number of the interface 31 of the data cable is multiple, types of the multiple interfaces may be the same or different, and may be, but are not limited to, one or more of a USB interface, a type-C interface, and a type-A interface.

The release control assembly 50 may serve as a structural member that may realize automatic retraction of the data cable 30 when the interface 31 of the data cable is in an idle state (e.g.,, suspended in the air and not connected to an external device), the specific representation form of the release control assembly 50 will be introduced in detail below.

The release control assembly 50 may be in electric connection with the data cable 30, so as to acquire connection state information of the interface 31 of the data cable. The release control assembly 50 may be configured to generate a control signal when it is acquired that the interface 31 of the data cable is not connected to the external device. The release control assembly 50 may not generate any control signal or may generate another control signal different from the above-mentioned control signal when it is acquired that the interface 31 of the data cable is connected to the external device. It needs to be noted that, when the data cable 30 is in an initial state of not being pulled out, the interface 31 of the data cable is also not connected to the external device, at which time the release control assembly 50 may not generate the above-mentioned control signal. In an example, only when the data cable 30 is pulled out under an external force to be in a positioned state after being pulled out, if the interface 31 of the data cable is not connected to the external device, the release control assembly 50 may generate the above-mentioned control signal.

The release control assembly 50 can cause the driving structure 22 to drive the winding frame 21 to rotate relative to the base 10 according to the control signal, so as to realize the automatic retraction of the data cable 30.

Based on the data cable device 1 in the example of the present disclosure, when the release control assembly 50 acquires that the interface 31 of the data cable generates a control signal when not connected to the external device, the driving structure 22 can be controlled to drive the winding frame 21 to rotate relative to the base 10 according to the control signal, so as to realize the automatic retraction of the data cable 30. Compared to the related art that a user realizes the automatic retraction of the data cable 30 by manually pressing a press key, the manual pressing operation of the user is omitted, which can effectively improve the convenience of automatic retraction of the data cable 30.

Further, the driving structure 22 can serve as the structural member for driving the winding frame 21 to rotate relative to the base 10 to realize the retraction of the data cable 30. The specific representation form of the driving structure 22 may be, but is not limited to, the following several examples.

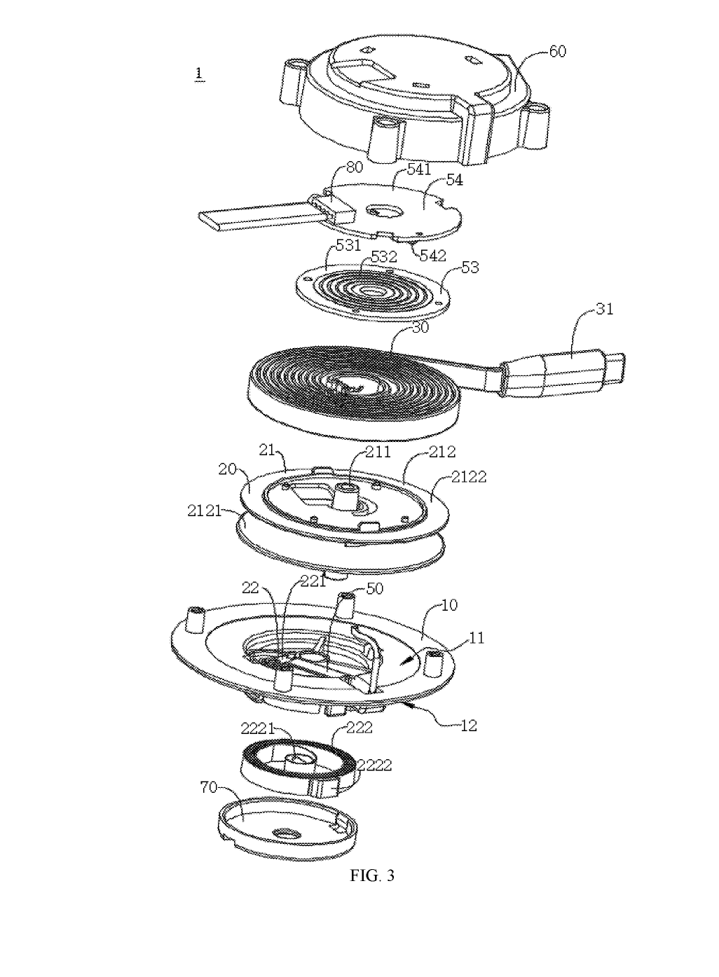

As shown in FIG. 3 to FIG. 7, in a first example, the base 10 has a first bearing surface 11. The winding frame 21 includes a rotary shaft 211 and a support frame 212. The rotary shaft 211 is in rotating connection with the base 10. The support frame 212 is located on a side of the base 10 where the first bearing surface 11 is located and is connected to the rotary shaft 211. A surface of the support frame 212 facing the first bearing surface 11 is provided with an annular guide groove 21211 which includes a catching point groove 21212. The data cable 30 is wound around the rotary shaft 211 and rests against a side of the support frame 212 facing away from the first bearing surface 11. The driving structure 22 includes a locking member 221 and a spiral spring 222. The release control assembly 50 drives the locking member 221 to rotate to detach from the catching point groove 21212 according to the control signal, and the rotary shaft 211 rotates under the action of an elastic restoring force of the spiral spring 222, thereby realizing the automatic retraction of the data cable 30.

In an example, the first bearing surface 11 may be a flat surface, a curved surface, or a combination of a flat surface and a curved surface. The rotary shaft 211 may be, but is not limited to be, connected to the base 10 through a bearing. The connection between the support frame 212 and the rotary shaft 211 may be a detachable connection or a non-detachable connection. For example, when the connection between the support frame 212 and the rotary shaft 211 is a detachable connection, the support frame 212 may be, but is not limited to be, connected to the rotary shaft 211 through one or more of manners such as screw connection, snap connection, and inserting connection. When the connection between the support frame 212 and the rotary shaft 211 is a non-detachable connection, the support frame 212 may, but is not limited to, form a one-piece structure with the rotary shaft 211 through a manner of injection molding or 3D printing, or connected to the rotary shaft 211 through a manner of adhesive bonding. Here, the specific trajectory shape of the annular guide groove 21211 is not limited, and the designer can make reasonable designs according to actual needs. The catching point groove 21212 is a groove segment in the annular guide groove 21211 that can realize a relatively fixed position between the support frame 212 and the base 10. The locking member 221 serves as a structural member for realizing the relatively fixed position between the support frame 212 and the base 10. In other words, the support frame 212 and the base 10 realize the relatively fixed position therebetween through the locking member 221, and the specific structure of the locking member 221 will be introduced in detail below.

In an example, the base 10 further has a second bearing surface 12 provided opposite to the first bearing surface 11. The locking member 221 is located between the first bearing surface 11 and the support frame 212 and is in rotating connection with the base 10, and a part of the locking member 221 is embedded in the annular guide groove 21211. The spiral spring 222 is located on a side of the base 10 where the second bearing surface 12 is located, a moving end 2221 of the spiral spring is connected to the rotary shaft 211, and a non-moving end 2222 of the spiral spring is connected to the base 10.

In an example, the locking member 221 may be connected to the base 10 through at least one of a bearing, another rotary shaft 211, or a pin shaft. Here, the specific connection manners between the moving end 2221 of the spiral spring and the rotary shaft 211, and between the non-moving end 2222 of the spiral spring and the base 10 are not limited, and the designer can make reasonable designs according to actual needs. For example, the moving end 2221 of the spiral spring may be, but is not limited to be, connected to the rotary shaft 211 through a manner of adhesive bonding, snap connection, or inserting connection, and the non-moving end 2222 of the spiral spring may be, but is not limited to be, connected to the base 10 through a manner of adhesive bonding, snap connection, or inserting connection. The specific connection manners between the moving end 2221 of the spiral spring and the rotary shaft 211, and between the non-moving end 2222 of the spiral spring and the base 10 will be introduced in detail below.

It needs to be noted that, when the data cable 30 is in an initial state of not being pulled out, a part of the locking member 221 embedded in the annular guide groove 21211 (e.g., a locking protrusion 2212 to be introduced below) is at a position where the catching point groove 21212 of the annular guide groove 21211 is located, and the position between the support frame 212 and the base 10 is relatively fixed. When the data cable 30 is pulled out under the external force and is in an extended state, the data cable 30 may drive the rotary shaft 211 and the support frame 212 to rotate synchronously, the synchronous rotation of the rotary shaft 211 and the support frame 212 may drive the part of the locking member 221 embedded in the annular guide groove 21211 to detach from the catching point groove 21212, so as to cause the locking member 221 to swing, and the swing of the locking member 221 causes the part of the locking member 221 embedded in the annular guide groove 21211 to perform periodic motion in the annular guide groove 21211. When the data cable 30 is pulled out to a suitable length, the part of the locking member 221 embedded in the annular guide groove 21211 may be again at the position where the catching point groove 21212 of the annular guide groove 21211 is located, and the position between the support frame 212 and the base 10 is relatively fixed, so as to realize positioning after pulling out the data cable 30.

The release control assembly 50 may drive, according to the control signal, the locking member 221 to rotate to detach from the catching point groove 21212 of the annular guide groove 21211. The rotary shaft 211 may rotate under the action of the elastic restoring force of the spiral spring 222 and drive the support frame 212 connected thereto to rotate synchronously, thereby realizing the automatic retraction of the data cable 30. It needs to be noted that, under the action of the release control assembly 50, the locking member 221 can cause the part of the locking member 221 embedded in the annular guide groove 21211 to detach from the catching point groove 21212, and swing under the action of the elastic restoring force of the spiral spring 222 in the axial direction of the rotary shaft 211, and the swing of the locking member 221 can cause the part of the locking member 221 embedded in the annular guide groove 21211 to perform periodic swing in the annular guide groove 21211, so as to realize the automatic retraction of the data cable 30. When the data cable 30 is completely retracted, the part of the locking member 221 embedded in the annular guide groove 21211 may again be at the position where the catching point groove 21212 of the annular guide groove 21211 is located, and the position between the support frame 212 and the base 10 is relatively fixed, so that positioning after retracting the data cable 30 may be realized, and the data cable 30 is again in the above-mentioned initial state.

The release control assembly 50 can generate a control signal when it is acquired that the interface 31 of the data cable is not connected to the external device, the release control assembly 50 drives the locking member 221 to rotate according to the control signal, so as to cause the part of the locking member 221 embedded in the annular guide groove 21211 to detach from the catching point groove 21212, so that the part of the locking member 221 embedded in the annular guide groove 21211 performs periodic motion in the annular guide groove 21211, thereby realizing the automatic retraction of the data cable 30; compared to the fact that a user realizes the automatic retraction of the data cable 30 by manually pressing a press key in the related art, the manual pressing operation of the user is omitted, which can effectively improve the convenience of automatic retraction of the data cable 30. When the release control assembly 50 drives the locking member 221 to rotate to detach from the catching point groove 21212 according to the control signal, the data cable 30 realizes automatic retraction under the action of the elastic restoring force of the spiral spring 222 about the axis of the rotary shaft 211. This structure is simple, and the operation is convenient.

The spiral spring 222 and the support frame 212 may be provided on two sides of the base 10 respectively, which on the one hand can effectively avoid the possibility of mutual winding between the data cable 30 and the spiral spring 222 during the retracting process, and on the other hand can fully utilize the space on both sides of the base 10 and effectively reduce the volume of the base 10 and the support frame 212, thereby reducing the overall volume of the data cable device 1.

In a second example, the driving structure 22 may include a driving motor (not shown in the figures), the driving motor is installed on the base 10, and a driving shaft of the driving motor is connected to the rotary shaft 211. The release control assembly 50 can generate a control signal when it is acquired that the interface 31 of the data cable is not connected to the external device, and controls the driving shaft of the driving motor to rotate according to the control signal to drive the rotary shaft 211 to rotate, thereby realizing the automatic retraction of the data cable 30.

Further, as shown in FIG. 3 to FIG. 7, when the driving structure 22 includes the locking member 221 and the spiral spring 222, it is considered that the release control assembly 50, on the one hand, can acquire the connection state of the interface 31 of the data cable, and on the other hand, can select whether to drive the locking member 221 to rotate according to different connection states of the interface 31 of the data cable, so as to realize automatic retraction of the data cable 30. In order that the release control assembly 50 has the corresponding function, it is thus designed that, in some examples, the release control assembly 50 includes a controller (not shown in the drawings) and a releasing member 51. The controller is in electric connection with the data cable 30, and is configured to acquire the connection state of the interface 31 of the data cable. The releasing member 51 is connected to the base 10 and is in electric connection with the controller. The controller is configured to generate a control signal when it is acquired that the interface 31 of the data cable is not connected to the external device (e.g., detecting there is no electric connection), and control the releasing member 51 to drive the locking member 221 to rotate to detach from the catching point groove 21212 according to the control signal. The releasing member 51 can serve as a power source for driving the locking member 221 to move, and the specific representation form of the releasing member 51 will be introduced in detail below.

The controller is configured to acquire the connection state of the interface 31 of the data cable, and the controller can generate a control signal when it is acquired that the interface 31 of the data cable is not connected to the external device. The releasing member 51 is in electric connection with the controller, so that the controller can control the releasing member 51 according to the control signal to drive the locking member 221 to rotate to detach from the catching point groove 21212, so as to realize the automatic retraction of the data cable 30.

Further, there are many specific application scenarios where the controller acquires the connection state of the interface 31 of the data cable to generate the above-mentioned control signal. For example, after the interface 31 of the data cable is disconnected from the external device, the controller may immediately start to acquire the connection state of the interface 31 of the data cable, and immediately generate the above-mentioned control signal when it is acquired that the interface 31 of the data cable is not connected to the external device. Or after the interface 31 of the data cable is disconnected from the external device, the controller may start to acquire the connection state of the interface 31 of the data cable after delay for a while, and immediately generate the above-mentioned control signal when it is acquired that the interface 31 of the data cable is not connected to the external device; or after the interface 31 of the data cable is disconnected from the external device, the controller may start to acquire the connection state of the interface 31 of the data cable only after delay for a while, and also generate the above-mentioned control signal only after delay for a while when it is acquired that the interface 31 of the data cable is not connected to the external device. In the example of the present disclosure, the controller includes a first controller (not shown in the drawings) and a second controller (not shown in the drawings). The first controller is in electric connection with the data cable 30 and is configured to acquire the connection state of the interface 31 of the data cable. The second controller is in electric connection with the first controller and the releasing member 51, the second controller starts time counting when the first controller acquires that the interface 31 of the data cable is not connected to the external device, the second controller generates a control signal when the counted time is greater than a preset time, and the second controller controls the releasing member 51 to drive the locking member 221 to rotate to detach from the catching point groove 21212 according to the control signal.

The first controller may be a PD chip, in which a register capable of acquiring the connection state of the interface 31 of the data cable is integrated. The second controller may be an MCU (Microcontroller Unit) or a PLC (Programmable Logic Controller), in which a time counter having a time counting function is integrated. Here, a specific value of the “preset time” is not limited, and the designer can make reasonable designs according to actual needs. For example, the preset time may be, but is not limited to, 5 minutes, 10 minutes, 15 minutes, 20 minutes, 25 minutes, or 30 minutes, etc. In this design, the first controller is configured to acquire the connection state of the interface 31 of the data cable. The second controller, on the one hand, is configured to start time counting when the first controller acquires that the interface 31 of the data cable is not connected to the external device, and generate a control signal when the counted time is greater than a preset time, and the second controller, on the other hand, controls the releasing member 51 to drive the locking member 221 to rotate to detach from the catching point groove 21212 according to the control signal, so as to realize the automatic retraction of the data cable 30.

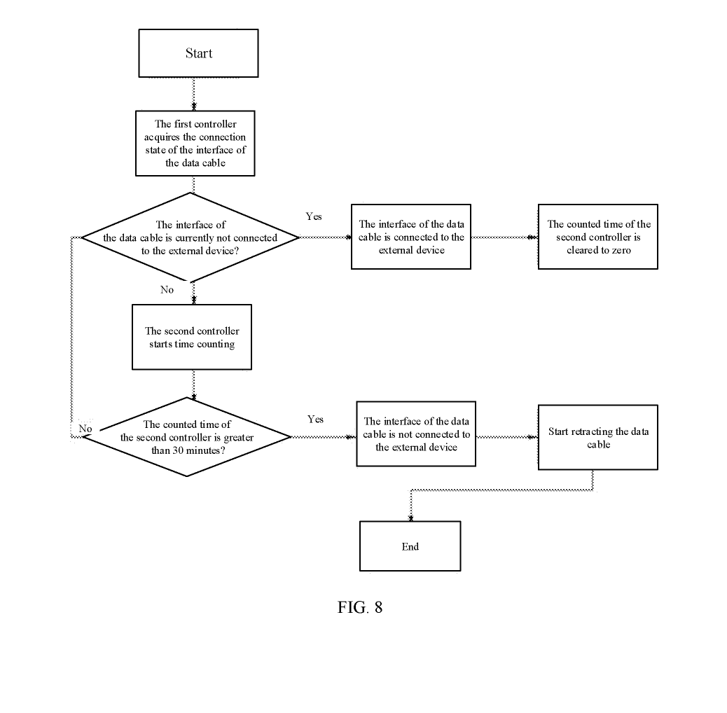

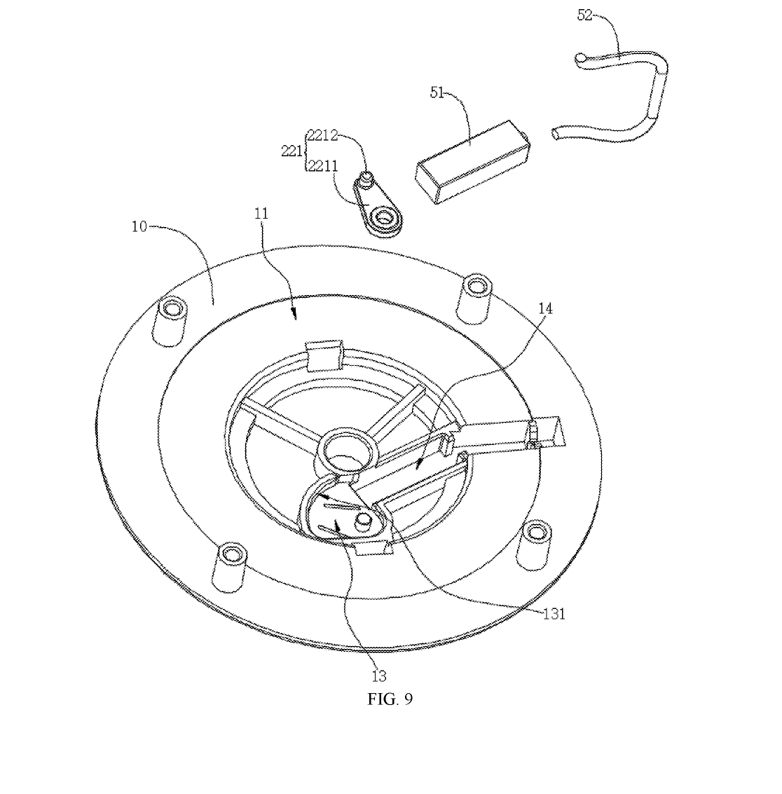

It needs to be noted that, after the interface 31 of the data cable is disconnected from the external device, the first controller immediately starts to acquire the connection state of the data cable interface 31. If, within this period of time when the counted time is less than the preset time, the interface 31 of the data cable connects the external device again, at this time, the counted time of the second controller may be cleared to zero. Until the interface 31 of the data cable is disconnected from the external device again, the second controller starts time counting again from zero. If the counted time is greater than the preset time, the controller controls the releasing member 51 to drive the locking member 221 to rotate to detach from the catching point groove 21212 according to the control signal, the data cable 30 realizes automatic retraction under the action of the elastic restoring force of the spiral spring 222, and when the data cable 30 completes retraction and is again in the above-mentioned initial state, the second controller may generate a judgment signal and judge that the interface 31 of the data cable is suspended in the air in the initial state according to the judgment signal. As shown in FIG. 8, FIG. 8 is a schematic flow chart of automatic retraction of the data cable 30 when the preset time is 30 minutes, and the control logic for the automatic retraction of the data cable 30 is not introduced in detail here.

In some other examples, the controller may be configured to acquire the connection state of the interface 31 of the data cable and start time counting when it is acquired that the interface 31 of the data cable is not connected to the external device, generates the above-mentioned control signal when the counted time is greater than the preset time, and controls the releasing member 51 to drive the locking member 221 to rotate to detach from the catching point groove 21212 according to the control signal.

Further, it can be understood that, the releasing member 51 serves as a power source for driving the locking member 221 to move, there may be many specific representation forms of the releasing member 51, and for releasing members 51 of different specific representation forms, the specific representation form of the locking member 221 is also not the same.

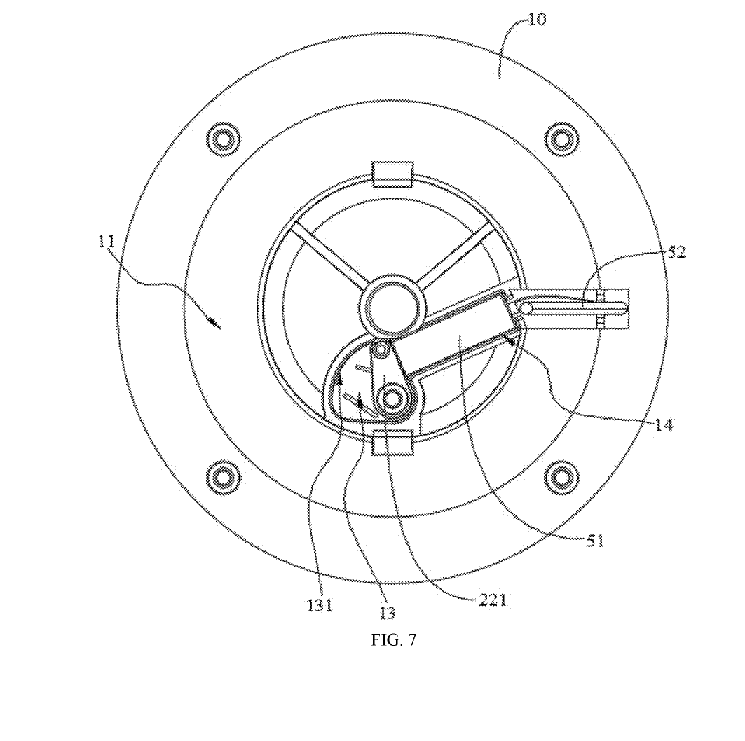

As shown in FIG. 6 to FIG. 7, in a first example, the releasing member 51 is suitable for being energized to generate magnetism, the locking member 221 has magnetism. When the counted time of the second controller is greater than the preset time, the second controller causes the releasing member 51 to be in an energized state according to the control signal, and the locking member 221 rotates to detach from the catching point groove 21212 under the action of the magnetic attraction force of the releasing member 51. The locking member 221 may be a permanent magnet, or may be an electromagnet that is energized to generate magnetism, which is similar to the releasing member 51. When the locking member 221 is an electromagnet, the second controller may cause the locking member 221 to be in the energized state according to the control signal, and at this time, the magnetism of the locking member 221 is opposite to the magnetism of the releasing member 51. It needs to be noted that, when the locking member 221 rotates under the action of the magnetic attraction force of the releasing member 51 to fit the releasing member 51, the releasing member 51 may be immediately deenergized, the locking member 221 is no longer subjected to the magnetic attraction force of the releasing member 51, so that the part of the locking member 221 embedded in the annular guide groove 21211 can perform periodic motion in the annular guide groove 21211 during the automatic retraction of the data cable 30.

In a second example, the releasing member 51 comprises a motor (not shown in the drawings). At this time, the locking member 221 does not have magnetism, and the rotary shaft 211 of the motor is connected to the locking member 221. When the counted time of the second controller is greater than the preset time, the second controller turns on the motor according to the control signal, and the locking member 221 rotates to detach from the catching point groove 21212 under the action of the driving force of the motor.

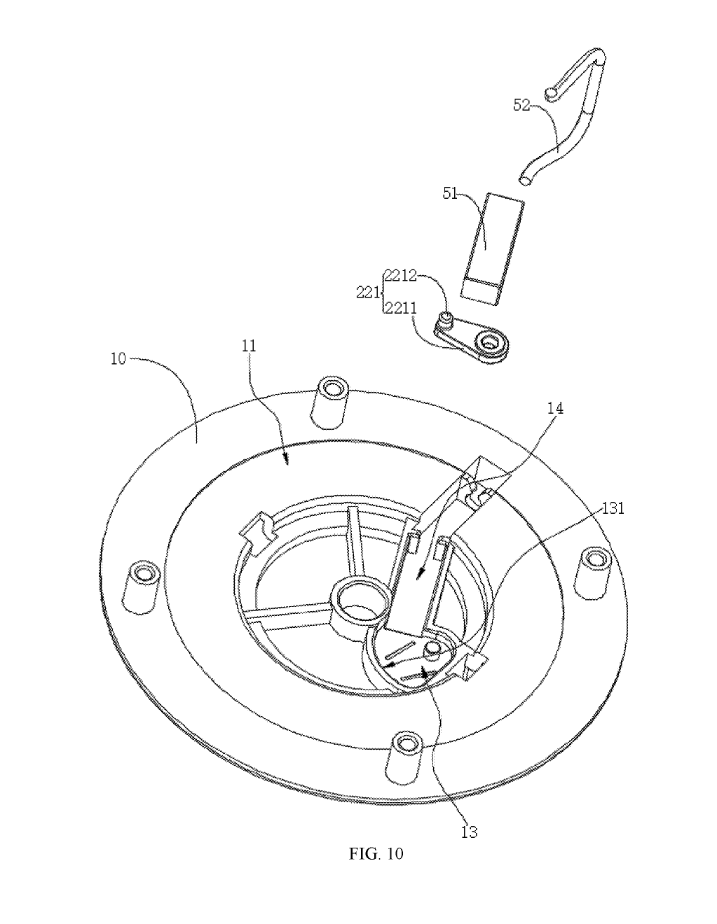

Further, as shown in FIG. 9 to FIG. 10, the specific providing manner of the locking member 221 on the base 10, and the specific providing manner of the releasing member 51 on the base 10 may be, but are not limited to, one or more of the following examples.

In a first example, the first bearing surface 11 of the base 10 is provided with a limiting groove 13, the limiting groove 13 has an arc-shaped groove sidewall 131 provided around a rotation axis of the locking member 221, at least a part of the locking member 221 is embedded in the limiting groove 13, and the locking member 221 is in contact with the arc-shaped groove sidewall 131. The contact between the locking member 221 and the arc-shaped groove sidewall 131 may be point contact, line contact, or surface contact. By designing the arc-shaped groove sidewall 131, when the locking member 221 rotates under the action of the releasing member 51, an end of the locking member 221 fits with the arc-shaped groove sidewall 131, which can effectively enhance stability of motion of the locking member 221.

In a second example, the first bearing surface 11 of the base 10 is provided with a snap connection groove 14, and the releasing member 51 fits into the snap connection groove 14. By designing the releasing member 51 to be in snap connection with the snap connection groove 14, installation difficulty of the releasing member 51 and the base 10 can be effectively reduced.

Further, as shown in FIG. 9 to FIG. 10, in some examples, the locking member 221 includes a locking main body 2211 and a locking protrusion 2212. The locking main body 2211 is embedded in the limiting groove 13 and is in rotating connection with a bottom wall of the limiting groove 13, and the locking main body 2211 is in contact with the arc-shaped groove sidewall 131. The locking protrusion 2212 is provided on a side of the locking main body 2211 facing away from the bottom wall of the limiting groove 13, and the locking protrusion 2212 is embedded in the annular guide groove 21211. When the counted time of the second controller is greater than the preset time, the releasing member 51 drives the locking main body 2211 to rotate to drive the locking protrusion 2212 to detach from the catching point groove 21212. The locking main body 2211 may be, but is not limited to, a “sector”-like block-shaped structure, a cross-section of the locking protrusion 2212 through a plane perpendicular to the rotation axis of the rotary shaft 211 may be, but is not limited to circular. The locking protrusion 2212 may be, but is not limited to be, form a one-piece structure with the locking main body 2211 through a manner of injection molding or 3D printing.

Further, it is considered that there may be many specific connection manners between the moving end 2221 of the spiral spring and the rotary shaft 211, and specific connection manners between the non-moving end 2222 of the spiral spring and the base 10, and the specific connection manners may be, but are not limited to, one or more of the following examples.

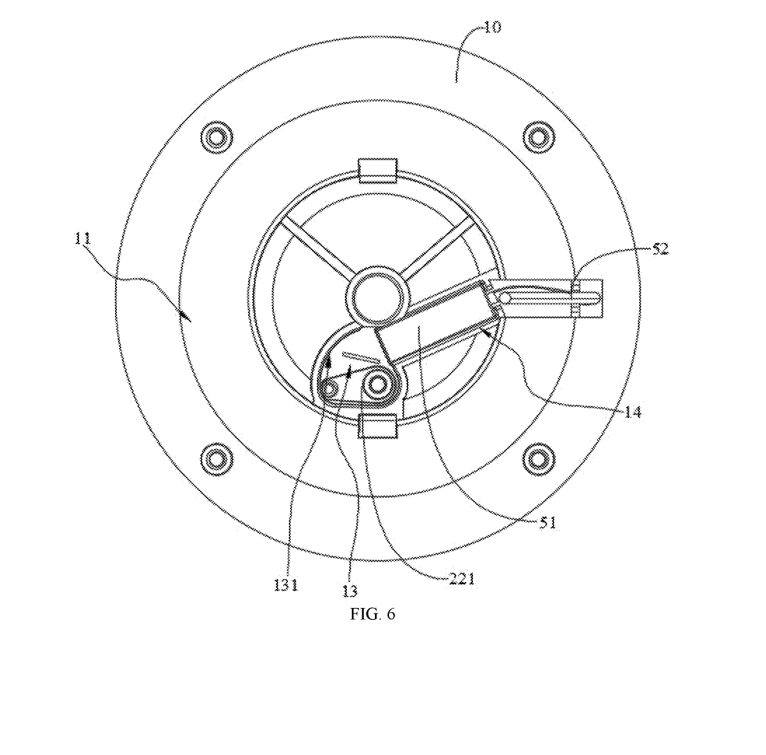

As shown in FIG. 3 and FIG. 5, in a first example, the moving end 2221 of the spiral spring is in snap connection with the rotary shaft 211, the rotary shaft 211 is provided with a slot 2111, and the moving end 2221 of the spiral spring fits into the slot 2111.

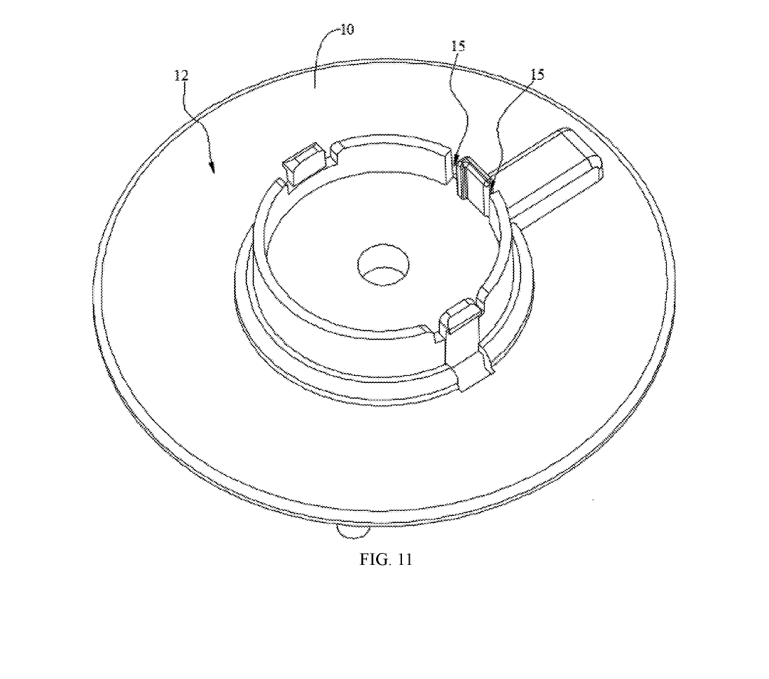

As shown in FIG. 3 and FIG. 11, in a second example, the non-moving end 2222 of the spiral spring is in snap connection with the base 10, the base 10 is provided with a notch 15, and the non-moving end 2222 of the spiral spring fits into the notch 15.

Further, as shown in FIG. 3 and FIG. 5, in some examples, the support frame 212 includes a first frame body 2121 and a second frame body 2122. The first frame body 2121 is in fixed connection with the rotary shaft 211. The second frame body 2122 is in fixed connection with the rotary shaft 211, the second frame body 2122 and the first frame body 2121 are spaced apart along an axis of the rotary shaft 211, and the second frame body 2122 is farther away from the first bearing surface 11 of the base 10 than the first frame body 2121. The data cable 30 is clamped between the second frame body 2122 and the first frame body 2121. At least two of the first frame body 2121, the second frame body 2122, and the rotary shaft 211 may, but are not limited to, form a one-piece structure through a manner of injection molding or 3D printing. In this design, the data cable 30 is clamped between the first frame body 2121 and the second frame body 2122, during the process of extending or shortening the data cable 30, the first frame body 2121 and the second frame body 2122 play a position-limiting role for the data cable 30, which can effectively ensure neatness of the data cable 30 wound around the rotary shaft 211, thereby effectively reducing the possibility of tying knots during the process of extending or shortening of the data cable 30.

Further, as shown in FIG. 1 and FIG. 3, in some examples, the data cable device 1 further includes a first cover body 60, at least part of the first cover body 60 is located on a side of the base 10 where the first bearing surface 11 is located, the first cover body 60 is connected to the base 10 to enclose and form a first accommodating cavity, the first cover body 60 has a wire-passing hole 61 for the data cable to pass through the first accommodating cavity. The release control assembly 50 further includes a first circuit board 53 and a second circuit board 54, the first circuit board 53 is located on a side of the second frame body 2122 facing away from the first bearing surface 11 and is connected to the second frame body 2122, and the first circuit board 53 is in electric connection with the data cable 30. The second circuit board 54 is located in the first accommodating cavity and is connected to the first cover body 60, and the second circuit board 54 is in electric connection with the first circuit board 53 and the controller.

The specific connection manner between the first cover body 60 and the base 10 is not limited here, and the designer can make reasonable designs according to actual needs; for example, the first cover body 60 may be, but is not limited to be, in fixed connection with the base 10 through a manner of screw connection, snap connection, and the like. In an example of the present disclosure, the first cover body 60 is connected to the base 10 through a manner of snap fit. Here, the specific providing position of the wire-passing hole 61 on the first cover body 60 is not limited, and the designer can make reasonable designs according to actual needs; for example, the wire-passing hole 61 may be provided on a top wall or a side wall of the first cover body 60. In an example of the present disclosure, the wire-passing hole 61 is designed on the side wall of the first cover body 60. The specific connection manner between the first circuit board 53 and the second frame body 2122 is not limited here, and the designer can make reasonable designs according to actual needs. For example, the first circuit board 53 may be, but is not limited to be, connected to the second frame body 2122 through a manner of screw connection, snap connection, or adhesive bonding; in the example of the present disclosure, the first circuit board 53 is connected to the second frame body 2122 through a manner of pin inserting connection. Here, the specific connection manner between the second circuit board 54 and the first cover body 60 is not limited, and the designer can make reasonable designs according to actual needs; for example, the second circuit board 54 may be, but is not limited to be, connected to the first cover body 60 through a manner of screw connection, snap connection, or adhesive bonding; in the example of the present disclosure, the second circuit board 54 is connected to the first cover body 60 through a manner of snap fit. The specific electric connection manner between the second circuit board 54 and the first circuit board 53 will be introduced in detail below.

Here, the specific connection manner between the controller and the second circuit board 54 is not limited, and the designer can make reasonable designs according to actual needs; for example, in the example of the present disclosure, the above-mentioned first controller and the above-mentioned second controller are both integrated on the second circuit board 54 and are in electric connection with the second circuit board 54. In some other examples, only the above-mentioned first controller may be integrated on the first circuit board 53 and in electric connection with the first circuit board 53, at which time the above-mentioned second controller is integrated on the second circuit board 54 and in electric connection with the second circuit board 54. Or the above-mentioned second controller may be integrated on the first circuit board 53 and in electric connection with the first circuit board 53, at which time the above-mentioned first controller is integrated on the second circuit board 54 and in electric connection with the second circuit board 54.

The first cover body 60 can play a good protective role for components such as the first frame body 2121, the second frame body 2122, and the data cable 30. Also, by designing the first circuit board 53 and the second circuit board 54, the first circuit board 53 and the second circuit board 54 realize the electric connection between the data cable 30 and the controller, the controller may generate a control signal when the interface 31 of the data cable is not connected to the external device, and control the releasing member 51 to drive the locking member 221 to rotate to detach from the catching point groove 21212 according to the control signal, thereby realizing the function that the data cable device 1 can realize automatic retraction of the data cable 30 when the interface 31 of the data cable is in the idle state.

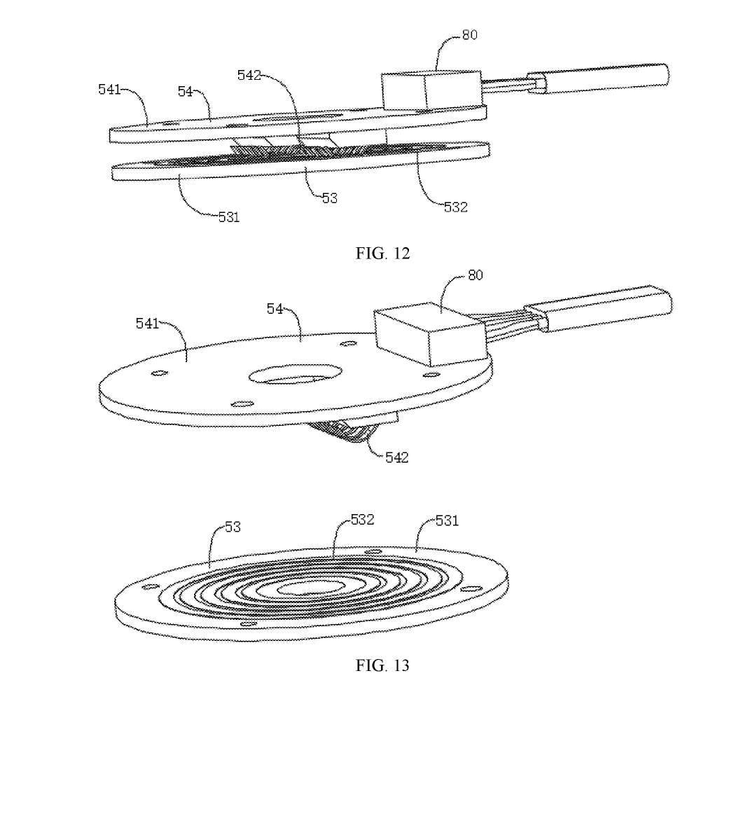

Specifically, as shown in FIG. 12 to FIG. 13, the specific electric connection manner between the first circuit board 53 and the second circuit board 54 may be, but is not limited to, the following several examples.

In a first example, the first circuit board 53 includes a first board body 531 and an electric connection piece 532, the electric connection piece 532 is an annular electric connection piece 532 provided around the axis of the rotary shaft 211, the first board body 531 is in fixed connection with the second frame body 2122, the annular electric connection piece 532 is provided on a side of the first board body 531 facing away from the first bearing surface 11 and is in electric connection with the first board body 531. The second circuit board 54 includes a second board body 541 and an electric contact point 542, the second board body 541 is in fixed connection with the first cover body 60, the electric contact point 542 is provided on a side of the second board body 541 facing the first bearing surface 11 and is in electric connection with the second board body 541. The electric contact point 542 is in contact with the annular electric connection piece 532. In this design, by designing the electric contact point 542 to be in contact with the annular electric connection piece 532, when the data cable 30 is extended or shortened, during a process of rotating following the second frame body 2122, the first circuit board 53 can always ensure the electric connection with the second circuit board 54, thereby effectively ensuring the power or signal transmission of the data cable 30.

In a second example, the first circuit board 53 may include a first board body 531 and an electric contact point 542, the first board body 531 is in fixed connection with the second support frame 212, the electric contact point 542 is provided on a side of the first board body 531 facing away from the first bearing surface 11 and is in electric connection with the first board body 531. The second circuit board 54 includes a second board body 541 and an electric connection piece 532, the electric connection piece 532 is an annular electric connection piece 532 provided around the axis of the rotary shaft 211, the second board body 541 is in fixed connection with the first cover body 60, the annular electric connection piece 532 is provided on a side of the second board body 541 facing the first bearing surface 11 and is in electric connection with the second board body 541. The annular electric connection piece 532 is in contact with the electric contact point 542.

Further, as shown in FIG. 9 and FIG. 10, in some examples, the release control assembly 50 further includes an electric connection member 52, one end of the electric connection member 52 is in electric connection with the releasing member 51, and the other end of the electric connection member 52 is in electric connection with the second circuit board 54. Thee releasing member 51 realizes the electric connection with the second circuit board 54 through the electric connection member 52. The electric connection member 52 may be, but is not limited to, a component having an electric connection function, such as a wire or a conductive piece.

In this design, the electric connection member 52 is configured to realize the electric connection between the releasing member 51 and the second circuit board 54, the controller may generate a control signal when the interface 31 of the data cable is not connected to the external device, control the releasing member 51 through the electric connection member 52 according to the control signal to drive the locking member 221 to rotate to detach from the catching point groove 21212, thereby realizing the function that the data cable device 1 can realize automatic retraction of the data cable 30 when the interface 31 of the data cable is in an idle state.

As shown in FIG. 3, in some other examples, the first cover body 60 further has a through hole 62 communicating with the first accommodating cavity; the data cable device 1 may further include a plug-in member 80, and the plug-in member 80 is in electric connection with the second circuit board 54 corresponding to the through hole 62. The plug-in member 80 may be a separate plug. The plug-in member 80 may be a separate interface (another interface different from the above-mentioned interface 31 of the data cable), the type of the interface may be, but is not limited to, a USB interface, a type-C interface, or a type-A interface. The plug-in member 80 may also be a combination of a plug and an interface. It needs to be noted that, when the data cable device 1 is used to charge an external device, the plug-in member 80 is connected to an external power source, and the interface 31 of the data cable is connected to the external device.

Further, as shown in FIG. 2 and FIG. 3, in some examples, the data cable device 1 further includes a second cover body 70, at least part of the second cover body 70 is located on a side of the base 10 where the second bearing surface 12 is located, the second cover body 70 is connected to the base 10 to enclose and form a second accommodating cavity, and the spiral spring 222 is located in the second accommodating cavity.

Here, the specific connection manner between the second cover body 70 and the base 10 is not limited, and the designer can make reasonable designs according to actual needs; for example, the second cover body 70 may be, but is not limited to be, in fixed connection with the base 10 through a manner of screw connection, snap connection, and the like; in the example of the present disclosure, the second cover body 70 is connected to the base 10 through a manner of snap fit.

The second cover body 70 and the base 10 may together enclose and form the second accommodating cavity, the spiral spring 222 is retracted in the second accommodating cavity, so as to play a good protective role for the spiral spring 222.

The same or similar reference numerals in the drawings of the examples correspond to the same or similar parts. In the description of the present disclosure, it should be understood that the terms “upper”, “lower”, “left”, “right”, and the like indicating orientation or position relationships are based on orientation or position relationships shown in the drawings, and are intended to describe the disclosure and simplify descriptions only and not to indicate or imply that the referred device or element must be provided, configured and operated in a particular orientation. Therefore, the terms used to describe position relationships are intended to be illustrative only and are not intended to limit the present disclosure. For those skilled in the art, specific meanings of the above terms can be understood according to specific situations.

The above are only preferred examples of the present disclosure and are not intended to limit the disclosure. Any modifications, equivalent substitutions, improvements or the like within the spirit and principle of the disclosure should be included in the scope of the disclosure.

What is claimed is:

1. A data cable device comprising:
a base;
a retracting assembly comprising a winding frame and a driving structure, wherein the winding frame is in rotating connection with the base, and the driving structure is connected to the winding frame and is configured to drive the winding frame to rotate relative to the base;
a data cable wound around the winding frame, wherein an interface of the data cable is configured to be connected to an external device; and
a release control assembly in electric connection with the data cable, wherein the release control assembly is configured to:
generate a control signal based on determining that the interface of the data cable is not connected to the external device, and
cause the driving structure to drive the winding frame to rotate relative to the base based on the control signal.

2. The data cable device of claim 1, wherein:
the base has a first bearing surface,
the winding frame comprises a rotary shaft and a support frame,
the rotary shaft is in rotating connection with the base,
the support frame is located on a side of the base where the first bearing surface is located and is connected to the rotary shaft,
a surface of the support frame facing the first bearing surface comprises an annular guide groove, the annular guide groove comprising a catching point groove,
the driving structure comprises a locking member and a spiral spring, and
the release control assembly is configured to drive the locking member to rotate to detach from the catching point groove based on the control signal, and drive the rotary shaft to rotate under an elastic restoring force of the spiral spring.

3. The data cable device of claim 2, wherein:
the base further has a second bearing surface opposite to the first bearing surface,
the locking member is located between the first bearing surface and the support frame and is in rotating connection with the base,
a part of the locking member is embedded in the annular guide groove, and
a moving end of the spiral spring is connected to the rotary shaft, and a non-moving end of the spiral spring is connected to the base.

4. The data cable device of claim 2, wherein the release control assembly comprises:
a controller in electric connection with the data cable, and configured to acquire a connection state of the interface of the data cable; and
a releasing member connected to the base and in electric connection with the controller, and
wherein the controller is configured to:
generate the control signal based on determining the interface of the data cable is not connected to the external device, and
control the releasing member to drive the locking member to rotate to detach from the catching point groove based on the control signal.

5. The data cable device of claim 4, wherein the controller comprises:
a first controller in electric connection with the data cable and configured to acquire the connection state of the interface of the data cable,
a second controller in electric connection with the first controller and the releasing member, wherein the second controller is configured to count time in response to the first controller determining that the interface of the data cable is not connected to the external device,
wherein the second controller is configured to generate the control signal based on the counted time being greater than a preset time.

6. The data cable device of claim 5, wherein:
the locking member comprises a magnet, and the releasing member is configured to be energized to generate magnetism, and
in response to the counted time being greater than the preset time, the second controller is configured to cause the releasing member to be in an energized state based on the control signal, and cause the locking member to rotate to detach from the catching point groove under a magnetic attraction force of the releasing member.

7. The data cable device of claim 5, wherein:
the releasing member comprises a motor,
the rotary shaft of the motor is connected to the locking member,
in response to the counted time being greater than the preset time, the second controller is configured to control the motor based on the control signal, and the locking member is configured to rotate to detach from the catching point groove under a driving force of the motor.

8. The data cable device of claim 5, wherein:
the first bearing surface comprises a limiting groove that has an arc-shaped groove sidewall around a rotation axis of the locking member,
at least a part of the locking member is embedded in the limiting groove, and
the locking member is in contact with the arc-shaped groove sidewall.

9. The data cable device of claim 4, wherein the first bearing surface comprises a snap connection groove, and the releasing member fits into the snap connection groove.

10. The data cable device of claim 3, wherein:
the moving end of the spiral spring is in snap connection with the rotary shaft,
the rotary shaft comprises a slot,
the moving end of the spiral spring fits into the slot.

11. The data cable device of claim 3, wherein the support frame comprises:
a first frame body in fixed connection with the rotary shaft; and
a second frame body in fixed connection with the rotary shaft, wherein the second frame body and the first frame body are spaced apart along an axis of the rotary shaft, and the data cable is clamped between the second frame body and the first frame body.

12. The data cable device of claim 2, wherein:
the base further has a second bearing surface opposite to the first bearing surface,
the data cable device further comprises a cover at least partially located on a side of the base where the second bearing surface is located, and
the cover is connected to the base to enclose and form an accommodating cavity in which the spiral spring is located.

13. A data cable device comprising:
a base;
a retracting assembly comprising a winding frame and a driving structure, wherein the winding frame is in rotating connection with the base, and the driving structure is connected to the winding frame and is configured to drive the winding frame to rotate relative to the base;
a data cable wound around the winding frame, wherein the data cable comprises an interface; and
a release control assembly, wherein the release control assembly is configured to cause, based on determining that the interface of the data cable not being connected to an external device, the driving structure to drive the winding frame to rotate relative to the base.

14. The data cable device of claim 13, wherein:
the winding frame comprises a rotary shaft and a support frame,
the rotary shaft is in rotating connection with the base,
the support frame is connected to the rotary shaft, and
a surface of the support frame comprises an annular guide groove, the annular guide groove comprising a catching point groove.

15. The data cable device of claim 14, wherein:
the driving structure comprises a locking member and a spiral spring, and
the release control assembly is configured to:
drive the locking member to rotate to detach from the catching point groove, and
drive the rotary shaft to rotate under an elastic restoring force of the spiral spring.

16. The data cable device of claim 15, wherein:
a part of the locking member is embedded in the annular guide groove, and
at least one of:
a moving end of the spiral spring is connected to the rotary shaft, or
a non-moving end of the spiral spring is connected to the base.

17. The data cable device of claim 15, wherein the release control assembly comprises:
a controller in electric connection with the data cable, and configured to acquire a connection state of the interface of the data cable; and
a releasing member connected to the base and in electric connection with the controller, and
wherein the controller is configured to:
generate a control signal based on determining the interface of the data cable is not connected to the external device, and
control the releasing member to drive the locking member to rotate.

18. The data cable device of claim 13, wherein the controller comprises:
a first controller in electric connection with the data cable and configured to acquire a connection state of the interface of the data cable,
a second controller in electric connection with the first controller, wherein the second controller is configured to count time in response to the first controller determining that the interface of the data cable is not connected to the external device, and
wherein the second controller is configured to generate a control signal based on the counted time being greater than a preset time.

19. The data cable device of claim 18, wherein:
the release control assembly comprises a releasing member connected to the base,
the driving structure comprises a magnet, and the releasing member is configured to be energized to generate magnetism, and
in response to the counted time being greater than the preset time, the second controller is configured to:
cause the releasing member to be in an energized state based on the control signal, and
cause the magnet to rotate under a magnetic attraction force of the releasing member.

20. A data cable device comprising:
a base;
a winding frame in rotating connection with the base;
a driving structure connected to the winding frame and is configured to drive the winding frame to rotate relative to the base;
a data cable wound around the winding frame, wherein the data cable comprises an interface; and
a release control assembly configured to cause automatic retraction of the data cable by controlling, based on determining that an interface of the data cable is not connected to an external device, the driving structure to drive the winding frame to rotate relative to the base.
